(19) United States
(12) Patent Application Publication
(10) Pub. No.: US 2004/0151461 A1
(43) Pub. Date: Aug. 5, 2004

(54) Broadband optical pump source for optical amplifiers, planar optical amplifiers, planar optical circuits and planar optical lasers fabricated using group IV semiconductor nanocrystals

(76) Inventor: Steven E. Hill, Castle Rock, CO (US)

Correspondence Address: DOWELL & DOWELL PC, SUITE 309, 1215 JEFFERSON DAVIS HIGHWAY, ARLINGTON, VA, 22202

(21) Appl. No.: 10/761,338

(22) Filed: Jan. 22, 2004

Related U.S. Application Data
(60) Provisional application No. 60/441,413, filed on Jan. 22, 2003.
(60) Provisional application No. 60/441,485, filed on Jan. 22, 2003.

(51) Int. Cl. G02B 6/10

(52) U.S. Cl. 385/129

(57) ABSTRACT

Planar optical circuits including amplifiers, splitters, Mach Zehnder interferometers are provided which make use of rare earth doped group IV semiconductor nanocrystals as an amplification medium.

### RELATED APPLICATIONS

This application claims the benefit of prior U.S. Application No. 60/441,413 filed Jan. 22, 2003 and No. 60/441,485 filed Jan. 22, 2003 which are hereby incorporated by reference in their entirety.

### FIELD OF THE INVENTION

The invention relates to broadband optical pump sources, planar optical amplifiers, planar optical circuits and planar optical lasers.

### BACKGROUND OF THE INVENTION

The dominant semiconductor material is silicon and it has been called the “engine” behind the information revolution. Silicon has poor optical activity due to its indirect band gap which has all but excluded it from optoelectronics applications whose exponential growth rate surpasses even the vaunted “Moore's Law” of silicon integrated circuits. In the past two decades there have been highly motivated attempts at developing a silicon-based light source that would allow one to have integrated digital information processing and optical communications capabilities in a single silicon-based integrated structure. For this to be of any practical use, a solution has to meet several important issues other than just generating light. The silicon Light Emitting Diode (LED) source should (1) emit at a technologically important wavelength, (2) achieve its functionality under practical conditions (e.g. temperature and pump power, and (3) offer a competitive advantage over existing technologies.

One of the materials that has gathered much international attention is erbium (Er) doped silicon (Si). The light emission from Er-doped Si occurs at the technological important 1.5 micron (πm) wavelength. This has the minimum optical absorption of silica-based optical fibers. By exciting the first excited state of the intra-4f shell atomic transition to the ground state of the Er³⁺, (⁴I_{13/2}-⁴I_{15/2}) it emits photons at the 1.5 micron wavelength. Furthermore it has been shown that both theoretical and experimental results suggest that Er in Si is Auger-excited via carriers, generated either electrically or optically, that are trapped at the Er-related defect sites and then recombine, and that this process can be very efficient due to the strong carrier-Er interactions. A schematic of the energy mechanisms of erbium doped silicon-rich silicone oxide is shown in FIG. 1.

If one tries this strong carrier-Er interaction in Er-doped bulk Si one sees a very reduced efficiency of the Er³⁺ luminescence at practical temperature and pump powers down to impractical levels. In recent papers it has been demonstrated that using silicon-rich silicone oxide (SRSO) which consists of Si nanocrystals embedded in a SiO₂ (glass) matrix reduces many of the problems associated with bulk Si and can have efficient room temperature Er³⁺ luminescence. The Si nanocrystals act a classical sensitizer atoms that absorb incident photons and then transfer the energy to the Er³⁺ ion, which then fluoresce at the 1.5 micron wavelength with the following significant differences. First, the absorption cross section of the Si nanocrystals is larger than that of the Er³⁺ ions by more than 3 orders of magnitude. Second, as excitation occurs via Auger-type interaction between carriers in the Si nanocrystals and Er³⁺ ions, incident photons need not be in resonant with one of the narrow absorption bands of the Er³⁺. However, existing approaches to developing such Si nanocrystals have only been successful at producing up to 0.03 percent atomic weight and this is not sufficient for practical applications, for example erbium 100 atomic percent of 5.81×10²² atoms cm⁻³, see Applied Physics Letter Vol 72, Num 9, 2 March 1998 pp1092-1094, J. Sin, M. Kim, S. Seo, and C. Lee.

In the area of opto-electronic packages, it is generally accepted that the most time consuming and costly component of the package is the alignment of the optical fiber, or wave guide, to the semiconductor emitter or receiver. The traditional approach to this alignment requires that the two parts be micromanipulated relative to each other while one is operating and the other is monitoring coupled light. Once the desired amount of coupled light is attained, the two parts must be affixed in place in such a way as to maintain this alignment for the life of the product. This process, commonly referred to as active alignment, can be slow and given to poor yields stemming from the micromanipulation and the need to permanently affix the two objects without causing any relative movement of the two with respect to each other.

To alleviate this problem, opto-electronic package designs have been suggested which incorporate passive alignment techniques. These designs do not require activation of the opto-electronic device. Generally, they rely on some mechanical features on the laser and the fiber as well as some intermediate piece for alignment. By putting the pieces together with some adhesion mechanism, alignment can be secured and maintained for the life of the component. Typical of this technology is the silicon optical bench design. In this design, the laser is aligned via solder or registration marks to an intermediate piece, a silicon part, which has mechanical features—“v-grooves”—which facilitate alignment of an optical fiber. The drawbacks to this design are the number of alignments in the assembly process and the cost of the intermediate component. Additionally, these designs can be difficult to use with surface emitting/receiving devices because of the need to redirect the light coupled through the system.

Other approaches have been suggested which do not incorporate a silicon intermediate structure. Swirhun et al. (U.S. Pat. No. 5,631,988) suggests that defined features in a surface emitting laser array could be used as an alignment means for a structure that holds embedded optical fibers. This third structure adds complexity and adds to the overall tolerance scheme for the alignment system.

In other prior art, attempts have been made to cope with the dilemma of adding intermediate parts and their associated costs and tolerances. Matsuda (U.S. Pat. No. 5,434,939) suggests a design that allows direct fiber coupling to a laser by way of a guiding hole feature in the backside of the actual laser substrate. The precision with which such guiding holes can be manufactured is not currently adequate for reliable coupling. Additionally, the process of making a hole in the actual laser substrate can weaken an already fragile material. Furthermore, this design is not appropriate when it is desired to have light emit from the top surface of the opto-electronic device, commonly called a top emitter in the vernacular of the industry. In contrast, a bottom emitter is a photonic device wherein the emitted light propagates through the substrate and out the bottom surface of the device.

What is needed is a photonic device that allows direct passive alignment and attachment of an optical signal carrying apparatus, such as an optical fiber for example, via robust guide features formed integrally on the surface of the photonic device. This photonic device would enable precise positioning of the fiber relative to the active region with the potential for sub-micron alignment accuracy without the addition of interfacial alignment components. Furthermore, it would be advantageous if the fabrication method for the above is compatible with standard semiconductor processing equipment.

Optical combiner devices are generally known. Such devices may be used to receive multiple pump signals via respective input ports and to combine the pump signals into an pump source. The input signals may have different operational wavelengths. The combined signal may be used to energize an optical amplifier, for example.

It has been suggested to locate fiber gratings upstream from the input ports of the combiner device to control and/or stabilize the wavelengths of the respective optical sources. One problem with this approach, however, is that it can be difficult to match the wavelength characteristics of the fiber gratings to the acceptance bandpass characteristics of the input ports. The spectral misalignment can be caused by normal manufacturing variations, by temperature variations, and by other factors. Any misalignment between the spectral characteristics of the gratings and the input ports of the combiner device can result in a loss of optical efficiency. This also has the caveat that the pump sources are coherent i.e. lasers.

In general, a fiber type light amplifier including an optical fiber having a core doped with a rare earth element such as erbium (Er) or the like is used as a light amplifier used in an optical communication system.

In a typical arrangement of a fiber type light amplifier, a signal light with a wave-length of 1.53 μm passing through an optical fiber is input to a wave synthesizer. The wave synthesizer synthesizes a pumping light with a wavelength of 1.48 μm supplied from a pumping light output unit and the signal light and supplies the same to an Er-doped optical fiber. The Er-doped optical fiber absorbs the pumping light and amplifies the signal light. A wave separator separates the amplified signal light from the pumping light which has not been absorbed by the Er-doped light fiber and outputs only the signal light to an optical fiber.

Nevertheless, this fiber type light amplifier has a drawback in that the attachment of the wave synthesizer and wave separator to the Er-doped optical fiber and the adjustment thereof is time consuming. Further, the miniaturization of the amplifier as a whole is difficult because a lower limit exists in the winding radius of the long Er-doped optical fiber and an extra length is needed to the portion of the Er doped optical fiber to be connected to the wave synthesizer and wave separator.

To overcome the above drawback, there is recently proposed a planar type optical amplifier including an amplifying core, a core having a function as a wave synthesizer, and a core having a function as a wave separator formed thereto, these cores being made by etching a glass film obtained by doping with a type IV semiconductor nanocrystal with a rare earth element such as erbium (Er) or the like on a silicon substrate or quartz glass substrate.

### SUMMARY OF THE INVENTION

According to one broad aspect, the invention provide a photonic device comprising at least one integral formed from a REDGIVN (rare earth doped group iv nanocrystal) material.

In some embodiments, the wave guide has a planar structure.

In some embodiments, the photonic device comprises a substrate and/or bottom cladding, a layer containing the REDGIVN material, and a lateral containment element adapted to laterally confine light to a region within the layer containing the REDGIVN material where the at least one wave guide is to be defined.

In some embodiments, the at least one wave guide is arranged to form a Mach Zehnder interferometer.

In some embodiments, the at least one wave guide are arranged to form an optical splitter.

In some embodiments, the photonic further comprises: a pump source adapted to activate the nanocrystals in the wave guide which in turn activate the rare earth element in the REDGIVN.

In some embodiments, the photonic device adapts to perform an amplification function upon an input optical signal to produce an amplified output optical signal.

In some embodiments, the photonic device comprises a substrate and/or bottom cladding, a layer containing the REDGIVN material, and a lateral containment element adapted to laterally confine light to a region within the layer containing the REDGIVN material where the at least one wave guide is to be defined.

In some embodiments, the pump source comprises an optical pump source.

In some embodiments, the optical pump source comprises a broadband optical pump source.

In some embodiments, the broadband optical pump source is arranged to transversely pump light into the at least one wave guide.

In some embodiments, the photonic device comprises a substrate and/or bottom cladding, a layer containing the REDGIVN material, and a lateral containment element adapted to laterally confine light to a region within the layer containing the REDGIVN material where the at least one wave guide, wherein the lateral containment element comprises an etched ribbed channel of spin on glass.

In some embodiments, the broadband source comprises at least one broadband LED (light emitting diode).

In some embodiments, the at least one broadband LED comprises a plurality of broadband LEDs arranged to collectively transversely pump the at least one wave guide.

In some embodiments, the photonic device further comprises coupling optics between each LED and the wave guide to focus light from the LED into the wave guide.

In some embodiments, the photonic device further comprises a reflection chamber surrounding the device to contain light within the device.

In some embodiments, the photonic device comprises an optical signal receiving surface through which light is received into the wave guide.

In some embodiments, said at least one wave guide comprises a plurality of wave guides, and wherein each LED pumps the plurality of wave guides.

In some embodiments, the photonic device further comprises an optical signal conveying surface through which the output signal is coupled to another optical element either directly or through free space optics.

In some embodiments, the wave guide is a plated wave guide formed in an opening in a resist prior to the resist being removed.

In some embodiments, optical pump source comprises an LED of a single or multiple wavelengths that cover a particular absorption band of the type IV semiconductor nanocrystals.

In some embodiments, the photonic device further comprises an optical taper used to transmit the combined light signal away from the broadband optical source, the taper using Total Internal Reflection (TIR) to direct the broadband source to the wave guide.

In some embodiments, the optical taper is an optical prism.

In some embodiments, the photonic device further comprises: at least one Holographic Optical Element (HOE) located after (downstream from) the optical pump source.

According to another broad aspect, the invention provides a photonic device comprising: an amplification medium comprising REDGINV; a plurality of light sources; a combiner adapted to combine light from the plurality of light sources to produce a broadband optical pump source which pumps light into the amplification medium.

In some embodiments, the plurality of light sources comprise a plurality of LEDs.

In some embodiments, the combiner comprises an lens, wherein there is self-alignment of the operational wavelengths of the LED sources to the acceptance angle characteristics of the input lens.

In some embodiments, the lens is a Plano-convex aspherical cylindrical design that has a small F# and short focal length to re-image the LED source and or sources to a planar output plane where the amplifying median is located.

In some embodiments, the combiner comprises a single or multiple micro-reflectors to efficiently the light signals into the broadband optical pump source.

According to another broad aspect, the invention provides a method of manufacturing a planar type optical amplifier comprising: forming a bar-shaped core on a plane substrate; forming a groove to the core which extends to the longitudinal direction thereof; filling the groove with a filler containing REDGIVN; and solidifying the filler.

According to another broad aspect, the invention provides a method of preparing a photonic device with an integral guide formed from a type IV semiconductor nanocrystal doped with rare earth ion material.

According to another broad aspect, the invention provides a method of preparing a REDGIVN wave guide on a photonic device comprising the steps of applying a resist, transferring an image to the resist, and developing the image.

According to another broad aspect, the invention provides a method of preparing a plated REDGIVN guide on a photonic device comprising the steps of applying a resist, transferring an image to the resist, developing the image, plating the resist, and removing the resist.

### BRIEF DESCRIPTION OF THE DRAWINGS

Preferred embodiments of the invention will now be described with reference to the attached drawings in which:

FIG. 1 is a schematic of energy mechanisms of erbium doped SRSO;

FIG. 2 is a perspective view of an example planar optical circuit provided by an embodiment of the invention;

FIG. 3 is a side view of a broadband optical pump provided by an embodiment of the invention;

FIG. 4 is a cross section of the broadband optical pump of FIG. 3; and

FIG. 5 is a side view of a planar optical amplifier provided by an embodiment of the invention.

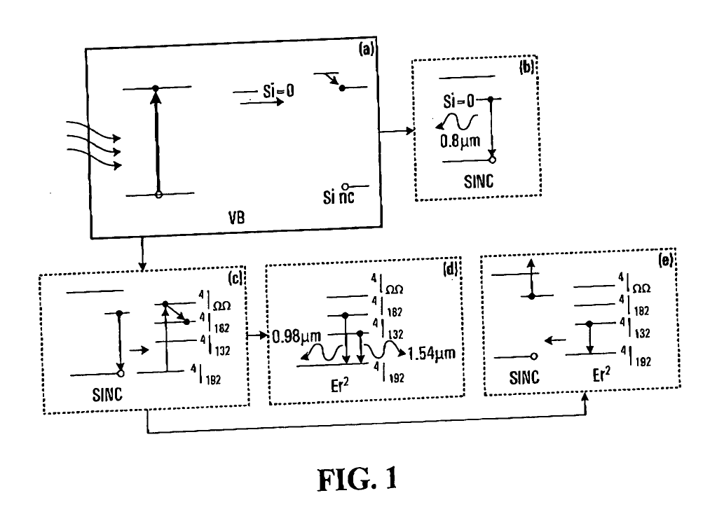

### DETAILED DESCRIPTION OF THE PREFERRED EMBODIMENTS

Applicants U.S. provisional application <attorney docket 50422-1> entitled “Preparation of type IV Semiconductor Nanocrystals Doped with Rare-earth Ions and Product Thereof” filed Jan. 22, 2003 teaches methods of preparing group IV semiconductor nanocrystals doped with rare-earth ions. In one embodiment provided in that application, the invention provides a doped type IV semiconductor nanocrystal layer. In another aspect, the invention provides a doped type IV semiconductor nanocrystal powder comprising crystals of a group IV element that bear on their surface atoms of one or more rare earth elements. The powder can also be used to form a layer, for example by including the powder in a layer of a dielectric medium for example spun glass, or a polymer. That application is incorporated herein in its entirety by reference. Two regular U.S. applications <attorney dockets 50422-7; 50422-8> based on the above provisional have been filed the same day as this application and are hereby incorporated by reference in their entirety. In the entire description that follows, whenever a rare-earth doped group IV semiconductor nanocrystal material (REDGIVN material) is referred to, any material taught in the incorporated documents is contemplated.

Planar Optical Circuits using IV Semiconductor Nanocrystals Doped with Rare-Earth Ions.

One embodiment of the present invention relates to the use of type IV semiconductor nanocrystals doped with rare earth ions, especially a silicon rich silicone oxide (SRSO), in the manufacturing of guide structures on photonic semiconductor wafers.

This embodiment provides a planar optical circuit that is manufactured by using IV semiconductor nanocrystals that are doped with rare-earth ions, and more generally any material generated/described in the above referenced incorporated applications, i.e. REDGIVN.

This technology provides an inexpensive method of producing planar optical circuits that could be used in the telecommunications field but not limited to just that field. This technology could also be used in advanced high speed back-planes and other high speed hybrid optoelectronic circuits.

The planar optical circuits are fabricated on flat substrates such as fused silica and or silicon and other such suitable substrate materials. The substrate could also be of a flexible nature assuming that the nanocrystal layer did not crack or peel due to the flexible nature of the substrate. By using silicon wafers as the substrate one then gains access to well-established process and fabrication manufacturing facilities throughout the world. Also by developing the flexible substrate technology exploit roll-web processes, which can be exploited allow one to print the planar optical circuits, as one would do for newspaper, magazines and other such printing technologies.

In a preferred embodiment, the use of the above described nanocrystals is employed in conjunction with a more conventional broadband light source to pump the Si nanocrystals rather than an expensive laser to pump one of the narrow absorption bands of the Er³⁺ ions. In a preferred embodiment, inexpensive long life visible wavelength LEDs are used which might have a broadband emission wavelength of about 20 nm for example compared to typical narrow band optical sources having emissions focussed within about 2 nm. This reduces the cost of the planar circuit greatly and also allows for a much easier assembly of the circuit. In a preferred embodiment, the planar circuit is pumped transversely from a top surface rather than trying to couple the pump light coaxial as is done with the pump laser EDFA and EDWA. The sensitizer Si nanocrystals also provide the refractive index contrast necessary for the wave guiding. One observes gain in the 1.54 λm wavelength that is coupled into the wave guide when the wave guide is pumped from the top, and demonstrates that such a wave guide satisfies all of the three aforementioned conditions necessary for a practical device.

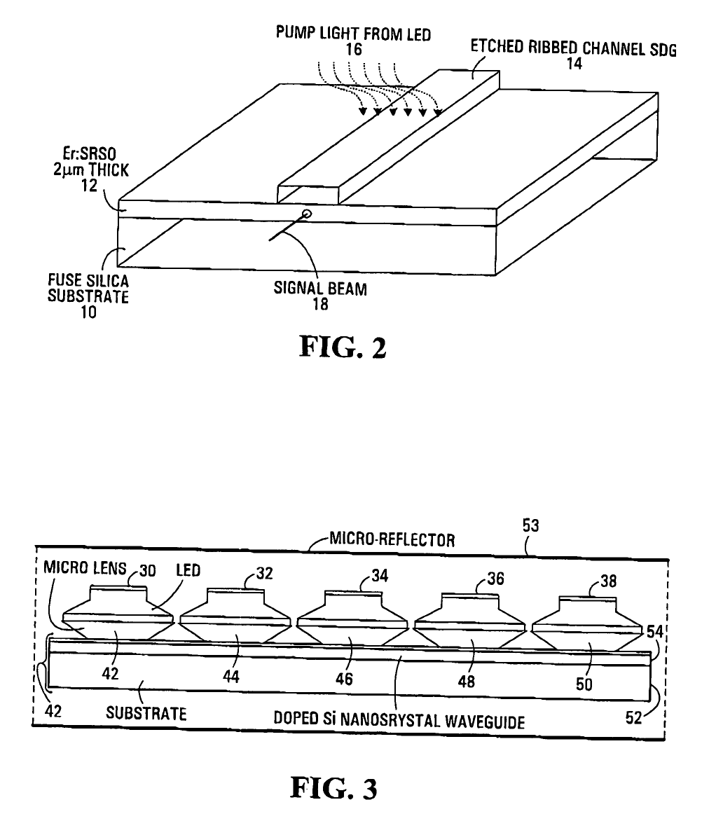

An example is shown in FIG. 2. Shown is a substrate 10, for example a fused silica substrate on top of which is located a REDGIVN layer, for example erbium doped SRSO. Depending on the substrate, a separate bottom cladding layer (not shown) may also be required. Also shown is an etched rib channel structure 14, for example formed using SOG (spin on glass). Pump light 16 is shown, for example originating from an LED (not shown). This pump light is shown pumping the planar circuit transversely from the top surface. Also shown is an input optical signal beam 18.

The etched ribbed channel 14 results in some lateral confinement of the optical modes in a particular region of the REDGIVN layer 12 below the channel. Other features may alternatively be employed for achieving this lateral confinement, referred to herein as optical confinement features. More generally, all that is required is that confinement to a channel of interest is achieved.

The example of FIG. 2 shows a very specific structure being implemented by the planar structure which includes a pump light source to thereby form an optical amplifier, namely a rib channel wave guide structure. It is to be understood that more generally any suitable structure can be formed in the planar arrangement. Other structures may alternatively be employed within the overall planar arrangement to result in confinement which achieves other functions such as Mach Zehnder interferometers and optical splitters to name a few examples, by appropriate definition of the lateral confinement features.

In the example of FIG. 2, the pump light is transversely pumped into the core. This has the advantage over co-axial pumping that light can more or less be uniformly applied throughout the length of the amplification medium. A co-axial pump source may alternatively be employed, but efficiency will be compromised due to losses along the amplification medium. The transverse pumping is an option in these embodiments because of the capacity to use a broadband pump, at lower pump power, all because of the increased activity of the REDGIVN material compared to conventional amplification mediums.

Preferably, the pump light is a broadband optical pump source, for example in the form of a broadband LED. In other words, in contrast to conventional EDFAs for example which require a very precise frequency pump source to activate the Erbium, with the use of the REDGIVN, the nanocrystals have a sensitivity to a much broader range of frequencies and as such a broad band pump source can be used. A single or multiple LEDs can be used as a pump source. Other pump sources are also contemplated. For example, silicon nanocrystals respond to 500 nm to 320 nm.

Various coupling mechanisms can be used in conjunction with the embodiment of FIG. 2. For example, one or both ends may be substantially flat so as to allow abutment up against another optical component to achieve efficient coupling of light to the input of the amplifier and from the output of the amplifier. Alternatively, free space optics may be employed at the input and/or the output to provide the necessary coupling of light. In the context of measuring signal strength using a tap detector, the output of the amplifier is fed to a sensor which detects the signal strength after amplification.

More generally, another embodiment of the invention provides a photonic device with an integral guide formed of REDGIVN. The arrangement of FIG. 2 provides but one example.

Another embodiment provides a method of preparing a photonic device with an integral guide formed from REDGIVN. The REDGIVN material is fabricated for example using methods taught in any of the incorporated applications. The remainder of the device can be fabricated using any appropriate method, many such methods being well known.

One method of preparing a guide on a photonic device involves the steps of applying a resist, transferring an image to the resist, and developing the image. Another method of preparing a plated guide on a photonic device involves applying a resist, transferring an image to the resist, developing the image, plating the resist, and removing the resist.

Broad Band Optical Pump

Another aspect of the invention relates generally to optical devices and systems, especially to telecommunications systems, optical amplifier systems, and/or wavelength division multiplexing systems. The present invention also relates to devices for combining multiple optical pump sources into one or more combined pump sources.

This embodiment of the invention provides a broad band optical pump source that is used to excite IV semiconductor nanocrystals that are doped with rare-earth ions. The purpose of this technology is to allow one to develop an inexpensive method of pumping planar optical amplifiers that could be used in the telecommunication field but not limited to just that field. This technology could also be used in advanced high speed back-planes and other high speed hybrid optoelectronic circuits.

The broad band optical pump sources are preferably LEDs that are mounted on flat or curve substrates such as fused silica and/or silicon and other such suitable substrate materials. The substrate could also be of a flexible nature assuming that the LEDs did not crack or peel due to the flexible nature of the substrate. The LEDs are arranged so that the maximum amount of light is directed to the REDGIVN material that is being used in the optical amplifier and or optical amplifiers. This might for example include micro-lens and or micro-reflectors to direct the LEDs light to the type IV semiconductor nanocrystals. In the preferred embodiment light is transversely pumped into the gain medium but is not strictly limited to this geometry of pumping.

Each LED can be of a single or multiple wavelengths that cover the particular absorption band of the type IV semiconductor nanocrystals. For example, he pump wavelength of choice for silicon nanocrystals in the near UV and blue region running from about 320 nm to 500 nm, although one could use other LED sources for example a source with light output at 670 nm at a reduction in pump efficiency. The pump source can be a single or multiple emitter source configured to illuminate the optical active gain media by being in close proximity to the gain media and/or by using micro-optics to gather and redirect the pump source to the gain media by refraction or reflective and/or diffractive means.

Referring now to FIG. 3, shown is a side view of a broadband optical pump provided by the embodiment of the invention. In this example, shown are a set of LEDs, five in this particular case, 30,32,34,36,38, although more generally any number can be employed. Each LED has a respective coupling optics 42,44,46,48,50 for coupling the light signal generated by the respective LED to the planar structure 40 below, and in particular for focussing the light into the REDGIVN layer 54. In one embodiment, the coupling optics can be a microlens. Other coupling optics can alternatively be employed. The planar structure 40 comprises a substrate 52 on top of which is defined the REDGIVN 54 containing at least one doped nanocrystal wave guide. More generally, a wave guide doped with any of the materials of the incorporated embodiments can be employed. The LEDs may all be the same, or they may be different. Advantageously, as described previously, these can be broadband LEDs. Specific single wavelength sources may also be employed, but this would increase cost significantly with no real advantage. A larger number of LEDs will increase the amount of pumping energy available. Also shown is a micro-reflector 53 which contains light within the arrangement.

The arrangement of FIG. 3 efficiently combines the pump light signals within the amplification medium.

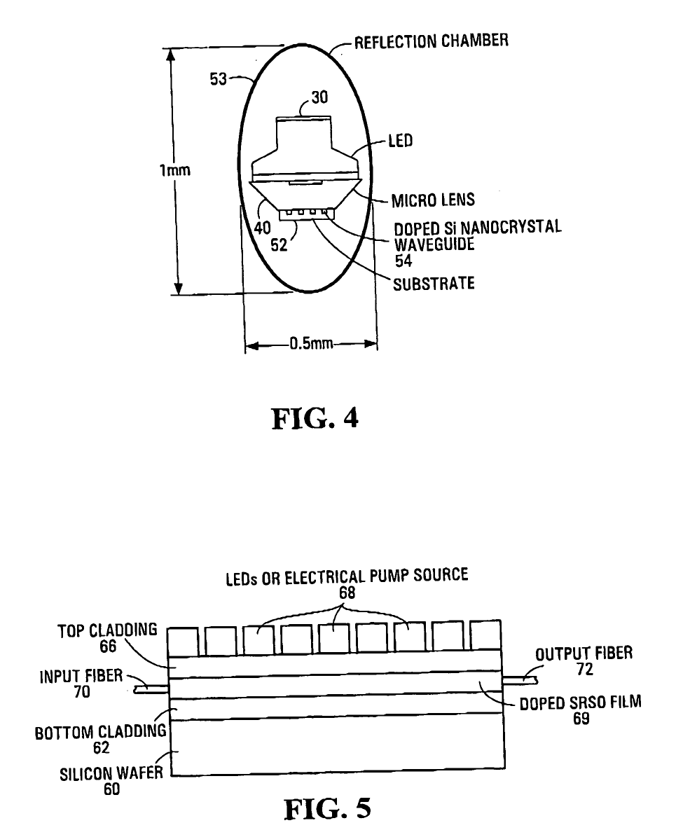

A cross section of the LED pump chamber of FIG. 3 is shown in FIG. 4. Here, one of the LEDs 30 is shown together with the coupling optics 40 in the form of a microlens, substrate 52 within which four doped Si nanocrystal wave guides are defined. More generally, at least one channel is defined, either in or on the substrate. The reflection chamber, or micro-reflector 53 is more easily seen in this view. This keeps light in the arrangement. It might for example be an aluminized piece of glass, or polished metal. The arrangement can be implemented without this component, but with reduced efficiency.

The example of FIG. 3 and FIG. 4 assumes five LEDs, and four wave guides. More generally, an arbitrary number of LEDs, and an arbitrary number of wave guides which do not necessarily need to be parallel are defined.

Referring row to FIG. 5 shown is a planar optical amplifier provided by an embodiment of the invention. This embodiment features a silicon substrate 60. Upon this is formed a wave guide structure comprising a bottom cladding layer 62, a core REDGIVN layer 64 for example consisting of doped SRSO film, and a top cladding layer 66. More generally, any suitable substrate can be employed and the core contains group IV semiconductor nanocrystals that are doped with rare-earth ions. Also shown is an input fiber 70 interfacing with a first end of the arrangement, and an output fiber 72 interfacing with a second end of the arrangement. More generally any optical coupling means can be employed for an input and output to the device. Also shown is a set of LEDs 68. With LEDs, the arrangement of FIG. 5 is not that different from the arrangement of FIG. 3. However, in another embodiment, the pump source 68 is an electrical pump source. This requires that the top and bottom cladding be conductive, and the substrate if present also be conductive such that electric field can be applied across the layer 69. For example, the cladding might be ZnO or AlN, and the substrate might be n+ or p+ doped silicon.

Another embodiment provides a method of efficiently combining input light signals into a combined light signal, the combined light signal then being used as an optical pump source for the REDGIVN. The method operates without any fiber gratings or other spectral filtering devices between the sources and the combiner device. Instead of gratings in the input fibers, the invention provides wavelength selection by the LED broadband sources. The method operates to self-align the operational wavelengths of the LED sources to the acceptance angle characteristics of the input lens, the lens functioning as a combiner. The lens may for example have a Plano-convex aspherical cylindrical design that has a small F# and short focal length to re-image the LED source and or sources to a planar output plane where the amplifying medium is located.

In a preferred embodiment of the invention such as shown by way of example in FIGS. 3 and 4, a single or multiple micro-reflectors are employed to efficiently combine input light signals into a combined light signal. The method operates without any fiber gratings or other spectral filtering devices between the sources and the combiner device. Instead of gratings in the input fibers, the invention provides wavelength selection by the LED broadband sources. The method operates to self-align the operational wavelengths of the LED sources to the acceptance angle characteristics of the micro-reflectors. The micro-reflector is a convex aspherical cylindrical design that has a small F# and short focal length to re-image the LED source and or sources to a planar output plane where the amplifying median is located

In a preferred embodiment of the invention, a combiner is provided in the form of a single or multiple broadband Holographic Optical Element (HOE)'s are located after (downstream from) the LED source and or sources. Thus, the combiner device is located between the pump LED and or LEDs and the optical amplifying element. The diffraction of the combiner device (through the respective input ports) determine the wavelengths of the broadband light provided by the LED and or LEDs, such that the LED wavelengths are at the minimum loss wavelengths associated with the combiner device. Thus, efficient diffraction concentration can be obtained independent of operating temperatures, age of the system, etc.

Another embodiment provides a method of manufacturing the planar type optical amplifier which comprises the steps of (1) forming a bar-shaped core on a plane substrate, (2) forming a groove to the core which extends to the longitudinal direction thereof, (3) filling the groove with a filler doped with a rare earth element, and (4) solidifying the filler.

Numerous modifications and variations of the present invention are possible in light of the above teachings. It is therefore to be understood that within the scope of the appended claims, the invention may be practised otherwise than as specifically described herein.

We claim:

1. A photonic device comprising at least one integral waveguide formed from a REDGIVN (rare earth doped group iv nanocrystal) material.

2. A photonic device according to claim 1 wherein the wave guide has a planar structure.

3. A photonic device according to claim 2 comprising a substrate and/or bottom cladding, a layer containing the REDGIVN material, and a lateral containment element adapted to laterally confine light to a region within the layer containing the REDGIVN material where the at least one wave guide is to be defined.

4. A photonic device according to claim 1 wherein the at least one wave guide is arranged to form a Mach Zehnder interferometer.

5. A photonic device according to claim 1 wherein the at least one wave guide is arranged to form an optical splitter.

6. A photonic device according to claim 1 further comprising:
a pump source adapted to activate the nanocrystals in the wave guide which in turn activate the rare earth element in the REDGIVN.

7. A photonic device according to claim 6 adapted to perform an amplification function upon an input optical signal to produce an amplified output optical signal.

8. A photonic device according to claim 7 comprising a substrate and/or bottom cladding, a layer containing the REDGIVN material, and a lateral containment element adapted to laterally confine light to a region within the layer containing the REDGIVN material where the at least one wave guide is to be defined.

9. A photonic device according to claim 7 wherein the pump source comprises an optical pump source.

10. A photonic device according to claim 9 wherein the optical pump source comprises a broadband optical pump source.

11. A photonic device according to claim 10 wherein the broadband optical pump source is arranged to transversely pump light into the at least one wave guide.

12. A photonic device according to claim 11 comprising a substrate and/or bottom cladding, a layer containing the REDGIVN material, and a lateral containment element adapted to laterally confine light to a region within the layer containing the REDGIVN material where the at least one wave guide, wherein the lateral containment element comprises an etched ribbed channel of spin on glass.

13. A photonic device according to claim 10 wherein the broadband source comprises at least one broadband LED (light emitting diode).

14. A photonic device according to claim 13 wherein the at least one broadband LED comprises a plurality of broadband LEDs arranged to collectively transversely pump the at least one wave guide.

15. A photonic device according to claim 13 further comprising coupling optics between each LED and the wave guide to focus light from the LED into the wave guide.

16. A photonic device according to 15 further comprising a reflection chamber surrounding the device to contain light within the device.

17. A photonic device according to claim 1 comprising an optical signal receiving surface through which light is received into the wave guide.

18. A photonic device according to claim 14 wherein said at least one wave guide comprises a plurality of wave guides, and wherein each LED pumps the plurality of wave guides.

19. A photonic device according to claim 1 further comprising an optical signal conveying surface through which the output signal is coupled to another optical element either directly or through free space optics.

20. A photonic device according to claim 1 wherein the wave guide is a plated wave guide formed in an opening in a resist prior to the resist being removed.

21. A photonic device according to claim 9 wherein optical pump source comprises an LED of a single or multiple wavelengths that cover a particular absorption band of the type IV semiconductor nanocrystals.

22. A photonic device according to claim 9 further comprising an optical taper used to transmit the combined light signal away from the broadband optical source, the taper using Total Internal Reflection (TIR) to direct the broadband source to the wave guide.

23. A photonic device according to claim 22 wherein the optical taper is an optical prism.

24. A photonic device according to claim 9 further comprising:
at least one Holographic Optical Element (HOE) located after (downstream from) the optical pump source.

25. A photonic device comprising:
an amplification medium comprising REDGINV;
a plurality of light sources;
a combiner adapted to combine light from the plurality of light sources to produce a broadband optical pump source which pumps light into the amplification medium.

26. A photonic device according to claim 25 wherein the plurality of light sources comprise a plurality of LEDs.

27. A photonic device according to claim 26 wherein the combiner comprises an lens, wherein there is self-alignment of the operational wavelengths of the LED sources to the acceptance angle characteristics of the input lens.

28. A photonic device according to claim 27 wherein the lens is a Plano-convex aspherical cylindrical design that has a small F# and short focal length to re-image the LED source and or sources to a planar output plane where the amplifying media is located.

29. A photonic device according to claim 25 wherein the combiner comprises a single or multiple micro-reflectors to efficiently the light signals into the broadband optical pump source.

30. A method of manufacturing a planar type optical amplifier comprising:
forming a bar-shaped core on a plane substrate;
forming a groove to the core which extends to the longitudinal direction thereof;
filling the groove with a filler containing REDGIVN; and
solidifying the filler.

31. A method of preparing a photonic device with an integral guide formed from a type IV semiconductor nanocrystal doped with rare earth ion material.

32. A method of preparing a REDGIVN wave guide on a photonic device comprising the steps of applying a resist, transferring an image to the resist, and developing the image.

33. A method of preparing a plated REDGIVN guide on a photonic device comprising the steps of applying a resist, transferring an image to the resist, developing the image, plating the resist, and removing the resist.
